(19) United States
(12) Patent Application Publication
(10) Pub. No.: US 2007/0035452 A1
(43) Pub. Date: Feb. 15, 2007

(54) Patch antenna having a universal serial bus (USB) connection port

(76) Inventors: Hsin-Lung Lin, Hsinchu (TW); Teng-Chao Chiang, Hsinchu (TW)

Correspondence Address: HARNESS, DICKEY & PIERCE, P.L.C., P.O. BOX 8910, RESTON, VA, 20195, US

(21) Appl. No.: 11/199,075

(22) Filed: Aug. 9, 2005

(51) Int. Cl. H01Q 1/24

(52) U.S. Cl. 343/702; 343/700 MS

(57) ABSTRACT

A patch antenna having a universal serial bus (USB) connection port, comprising: a substrate; an antenna module, provided on the substrate and having a signal feed-in terminal, and used to transmit or receive a radio frequency signal; a universal serial bus connection port, connected to the signal feed-in terminal of the antenna module, and used to provide the antenna module with a signal transmission interface for transmitting the radio frequency signal; a signal conversion circuit, used to convert the format of the radio frequency signal to the format compatible with the signal transmission interface.

### BACKGROUND OF THE INVENTION

1. Field of the Invention

The invention relates to a patch antenna, in particular to a patch antenna having a universal serial bus (USB) connection port.

2. Related Art

With the rapid progress and development of the telecommunication industries, the communication between people has become more convenient, thus the data transmission rate has raised significantly. In telecommunication systems, the antenna is one of the most important and indispensable devices, which is mainly utilized to convert the audio/video signal of the transmitter into electromagnetic waves and transmit it to the receiving end. Then at the receiving end, the transmitted electromagnetic waves are received and converted back into the audio/video signals for further processing. The antenna presently in use may be classified as an outside-attaching type or a built-in type depending on its position. Usually, the outside-attaching type antenna is connected to the wireless communication module of the telecommunication device through the specific length of a signal transmission line and a connection interface. In general, the coaxial cable is utilized as the signal transmission line, and the BNC type or F type connector is utilized as the connection interface.

In addition, nowadays, the portable electronic device usually is provided with a plug-in-and-run capability for the convenience of the user. As such, such kind of portable electronic device is connected to other devices through the Universal Serial Bus (USB) interface and is operational requiring the related driving programs. However, when it is utilized as a wireless communication device requiring the outside-attaching antenna, the user has to carry the antenna and the related signal transmission line, and this wireless communication device is operational only after it is properly connected to the antenna and the related signal transmission line. As such, the wireless communication device may not be operational the antenna and the related signal transmission line, resulting in quite a lot of trouble and inconvenience for the users.

Therefore, the research and development of a portable patch antenna having a plug-in-and-run capability is an urgent task in this field.

### SUMMARY OF THE INVENTION

In view of the above-mentioned problems and shortcomings of the prior art, the object of the invention is to provide a patch antenna having a universal serial bus (USB) connection port (e.g. a connector or connection seat), which is enabled to have a plug-in-and-run capability through a built-in communication connection interface and a signal conversion circuit, thus facilitating the application of the patch antenna.

Therefore, to achieve the above-mentioned objective, the invention provides a patch antenna having the universal serial bus (USB) connection port according to the first embodiment, including: a substrate, an antenna module, a universal serial bus connector, and a signal conversion circuit. The details of each of these devices are described as follows.

The substrate, which is made of a printed-circuit-board (PCB) and is of a roughly rectangular shape;

The antenna module, which is provided on the substrate, including: a signal feed-in terminal, used to receive the radio frequency signal; a radiation portion, used to transmit said radio frequency signal, and a ground portion, used to provide the ground voltage for the patch antenna. The radiation portion and the ground portion may be disposed on the same or different surfaces of the substrate.

The universal serial bus connector, which has a male structure and is connected to the signal feed-in terminal of the antenna module, and is used to provide the antenna module with the signal transmission interface for transmitting the radio frequency signal.

The signal conversion circuit, which is provided between the signal feed-in terminal of the antenna module and the universal serial bus connector, and is used to convert the transmitted radio frequency signal to the format compatible with the format used in the signal transmission interface.

In the above-mentioned structure, the patch antenna is further provided with a shell body enclosing and protecting the substrate and the circuit elements disposed thereon. An indication lamp is provided on one side of the shell body for indicating the transmission state of the radio frequency signal.

Furthermore, the patch antenna is provided with fixing pieces, of which each is composed of a bond-ring and a suction-disc. The bond-ring is bonded onto the shell body, so that the patch antenna is fixed and secured onto the outside of the wireless communication device through the fixing pieces.

In addition, to achieve the above-mentioned objective, the invention provides a patch antenna having a universal serial bus (USB) connection port according to the first embodiment, including: a substrate, an antenna module, a universal serial bus connector, and a signal conversion circuit. The details of each of these devices are described as follows.

The substrate, which is made of a printed-circuit-board (PCB) and is of a roughly rectangular shape.

The antenna module, which is provided on the substrate, including: a signal feed-in terminal, used to receive the radio frequency signal; a radiation portion, used to transmit said radio frequency signal, and a ground portion, used to provide the ground voltage for the patch antenna, wherein the radiation portion and the ground portion may be disposed on the same or different surfaces of the substrate.

The universal serial bus connector, which is a female structure and is connected to the signal feed-in terminal of the antenna module, and is used to provide the antenna module with the signal transmission interface for transmitting the radio frequency signal.

The signal conversion circuit, which is provided between the signal feed-in terminal of the antenna module and the universal serial bus connector, and is used to convert the transmitted radio frequency signal to the format, compatible with the format as used in the signal transmission interface.

In the above-mentioned structure, the patch antenna is further provided with a shell body enclosing the substrate and the circuit elements disposed thereon, and an indication lamp is provided on one side of the shell body for indicating the transmission state of the radio frequency signal.

Furthermore, the patch antenna is provided with fixing pieces, of which each is composed of a bond-ring and a suction-disc. The bond-ring is bonded onto the shell body, so that the patch antenna is fixed and secured onto the outside of the wireless communication device through the fixing piece.

Through the application of the patch antenna of the invention, having a universal serial bus (USB) connection port, the radio frequency signal is transmitted into the wireless communication device through the connector or the connection seat provided at the signal feed-in terminal of the patch antenna after undergoing format conversion, to facilitate the portability and the utilization of the patch antenna.

Further scope of the applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will become more fully understood from the detailed description given below, which is for illustration only and thus is not limitative of the invention, wherein:

FIG. 1 is a schematic diagram of the perspective view of the structure of the patch antenna having a universal serial bus (USB) connection port according to the first embodiment of the invention;

FIG. 2 is a schematic diagram of the perspective view of the structure of the patch antenna having a universal serial bus (USB) connection port according to the second embodiment of the invention; and

FIG. 3 is a schematic diagram of the fixing pieces bonded onto the patch antenna of the invention.

### DETAILED DESCRIPTION OF THE INVENTION

The purpose, construction, features, and functions of the invention can be appreciated and understood more thoroughly through the following detailed description with reference to the attached drawings.

The universal serial bus connection port of the patch antenna is composed of a connector or connection seat, and is described in detail by means of the following two embodiments.

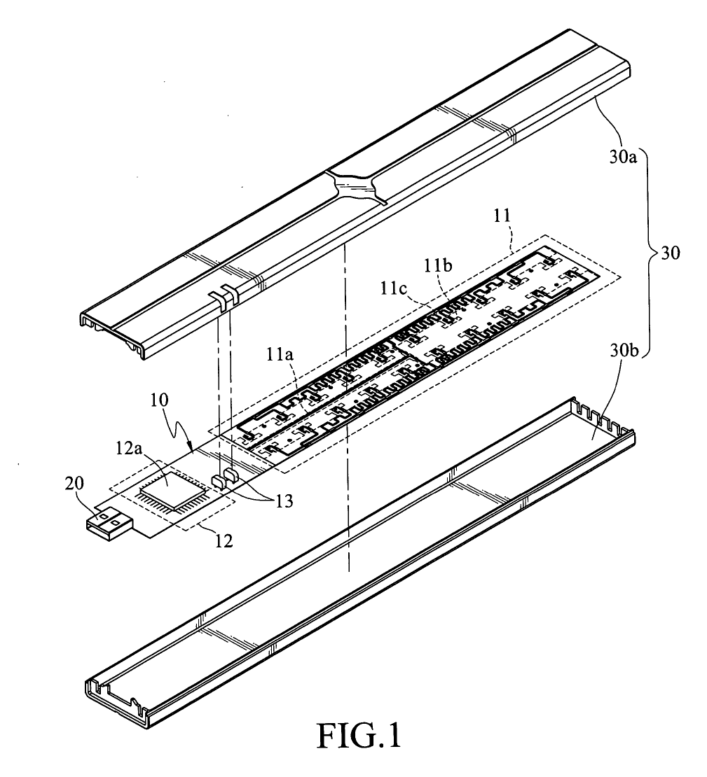

Refer to FIG. 1, for the schematic diagram of the perspective view of the structure of the patch antenna according to the first embodiment of the invention, including: a substrate 10, an antenna module 11, a universal serial bus connector 20, a signal conversion circuit 12, a shell body 30, and a state indication lamp 13. The details of each of these devices are described as follows.

The substrate 10, which is a roughly rectangular shape printed-circuit-board (PCB), and can be classified as a composite substrate, a ceramic substrate, a metallic substrate, a thermoplastic substrate, and a glass-fiber-copper-foil substrate.

The antenna module 11, which is used to receive and transmit the radio frequency signals, including: a signal feed-in terminal 11a, a radiation portion 11b, and a ground portion 11c. The signal feed-in terminal 11a is connected to the radiation portion 11b and ground portion 11c through the micro strip circuit, while the radiation portion 11b and ground portion 11c can be disposed on the same surface or different surfaces of the substrate 10. The circuit pattern of the antenna module 11 is realized through chemical etching. In addition, as shown FIG. 1, the radiation portion 11b (the T-shaped dashed line portion) and the ground portion 11c are provided on the same surface of the substrate, which is different from the surface on which the signal feed-in terminal 11a is disposed.

The universal serial bus connector 20, which is a male structure with its one end provided with a plurality of metallic pins, and is electrically connected to the signal feed-in terminal 11a of the antenna module 11, while the other end of the connector is connected to the wireless communication device (not shown), and is used to provide the antenna module 11 with the signal transmission interface for transmitting the radio frequency signal.

The signal conversion circuit 12, which is provided between the signal feed-in terminal 11a of the antenna module 11 and the universal serial bus connector 20, and is used to convert the transmitted radio frequency signal to the format compatible with the format as used in the signal transmission interface (namely, the universal serial bus connector 20). The circuit elements 12a of the signal conversion circuit 12 are bonded onto the surface of the substrate 10 by means of the Surface Mounted Technology (SMT).

The shell body 30, which is made of non-metallic material (for example, plastic or acrylic, etc) and is composed of an upper shell body 30a and a lower shell body 30b, which are bonded together to provide an accommodation space to receive and protect the substrate 10 and the circuit elements 12a disposed thereon. As such, the shell body 30 may be made into an integral body to receive and protect the substrate 10 and the circuit elements 12a disposed thereon.

The state indication lamp 13, which is provided on one side of the shell body 30 and is connected to the signal conversion circuit 12, and is utilized to indicate the transmission state of the radio frequency signal by making use of the voltage variations of the transmitted radio frequency signal. The state indication lamp 13 may be made of a light-emitting-diode (LED).

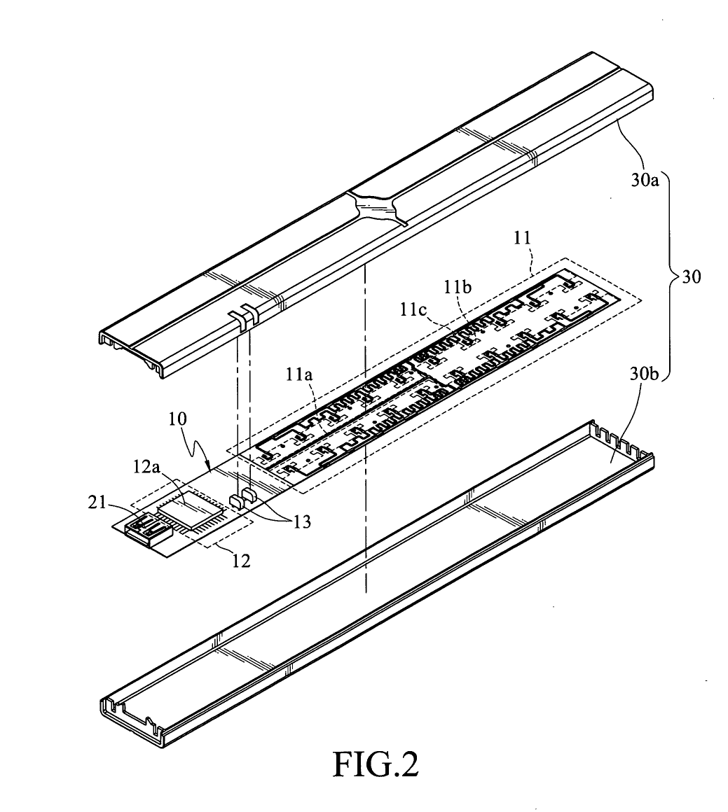

Next, refer to FIG. 2, for the schematic diagram of the perspective view of the structure of the patch antenna according to the second embodiment

of the invention, including: a substrate 10, an antenna module 11, a universal serial bus connection seat 21, a signal conversion circuit 12, a shell body 30, and a condition indication lamp 13. The details of each of these devices are described as follows (Note that the major difference between the first embodiment and the second embodiment is that the connector seat 21 is used in the second embodiment instead of the connector 20 used in the first embodiment).

The substrate 10, which is a roughly rectangular shape printed-circuit-board (PCB), and can be classified as a composite substrate, a ceramic substrate, a metallic substrate, a thermoplastic substrate, and a glass-fiber-copper-foil substrate.

The antenna module 11, which is used to receive and transmit the radio frequency signals, including: a signal feed-in terminal 11a, a radiation portion 11b, and a ground portion 11c. The signal feed-in terminal 11a is connected to the radiation portion 11b and ground portion 11c through a micro strip circuit, while the radiation portion 11b and ground portion 11c can be disposed on the same surface or different surfaces of the substrate 10. The circuit pattern of the antenna module 11 is realized through chemical etching. In addition, as shown FIG. 1, the radiation portion 11b ( the T-shaped dashed line portion) and the ground portion 11c are provided on the same surface of the substrate, which is different from the surface on which the signal feed-in terminal 11a is disposed.

The universal serial bus connection seat 21, which has a female structure with one end provided with a plurality of metallic pins, and is electrically connected to the signal feed-in terminal 11a of the antenna module 11, while the other end of the connection seat is connected to the wireless communication device (not shown), and is used to provide the antenna module 11 with the signal transmission interface for transmitting the radio frequency signal.

The signal conversion circuit 12, which is provided between the signal feed-in terminal 11a of the antenna module 11 and the universal serial bus connector 20, and is used to convert the transmitted radio frequency signal into the format compatible with the format as used in the signal transmission interface (namely, the universal serial bus connector 20). The circuit elements 12a of the signal conversion circuit 12 are bonded onto the surface of the substrate 10 by means of the Surface Mounted Technology (SMT).

The shell body 30, which is made of non-metallic material (for example, plastic, acrylic, etc.) and is composed of an upper shell body 30a and a lower shell body 30b, which are bonded together to provide an accommodation space to receive and protect the substrate 10 and the circuit elements 12a disposed thereon. As such, the shell body 30 may be made into an integral body to receive and protect the substrate 10 and the circuit elements 12a disposed thereon.

The state indication lamp 13, which is provided on one side of the shell body 30 and is connected to the signal conversion circuit 12, and is utilized to indicate the transmission state of the radio frequency signal by making use of the voltage variations of the transmitted radio frequency signal. The state indication lamp 13 may be made of a light-emitting-diode (LED).

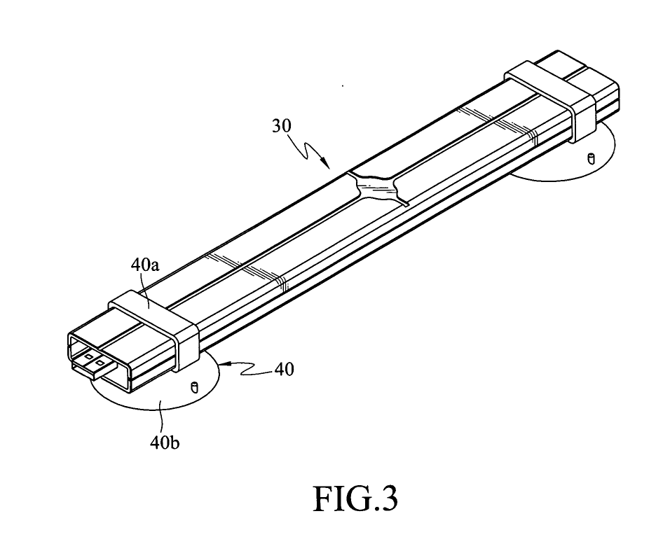

Finally, refer to FIG. 3, which shows the schematic diagram of the fixing pieces bonded onto the patch antenna of the invention. As shown in FIG. 3, both ends of the shell body 30 of the patch antenna are bonded with the fixing pieces 40 (their quantity depends on the actual requirement). The fixing piece 40 is composed of a bond-ring 40a and a suction-disc 40b. The bond-ring 40a is made of a plastic- elastic material, and is bonded onto the shell body 30 of the patch antenna. Thus, the patch antenna is suction-attached to the outer surface of equipment or a device (e.g. vehicle, wall, or machine) through the suction-disc 40b. The bond-ring 40a and the suction-disc 40b can be made as separate parts or integrally in one piece. In addition, the bond-ring 40a and the section disc 40b can be made of the same or different materials.

Through the application of the patch antenna having a universal serial bus (USB) connection port, the radio frequency signal is transmitted to the wireless communication device through the connector or the connector seat provided at the signal feed-in terminal of the patch antenna after undergoing format conversion, to facilitate the portability and the utilization of the patch antenna.

Knowing the invention being thus described, it will be obvious that the same may be varied in many ways. Such variations are to be regarded as a departure from the spirit and scope of the present invention, and all such modifications as would be obvious to one skilled in the art are intended to be included within the scope of the following claims.

What is claimed is:

1. A patch antenna having the universal serial bus (USB) connection port, comprising:
a substrate;
an antenna module, provided on said substrate and having a signal feed-in terminal, and is used to transmit or receive the radio frequency signal;
a universal serial bus connection port, connected to said signal feed-in terminal of said antenna module, and is used to provide said antenna module with signal transmission interface for transmitting said radio frequency signal; and
a signal conversion circuit, used to convert said radio frequency signal into format compatible with that as used in said signal transmission interface.

2. The patch antenna having the universal serial bus (USB) connection port as claimed in claim 1, wherein said substrate is a printed-circuit-board.

3. The patch antenna having the universal serial bus (USB) connection port as claimed in claim 1, wherein said universal serial bus (USB) connection port is a male-structured connector.

4. The patch antenna having the universal serial bus (USB) connection port as claimed in claim 1, wherein said universal serial bus (USB) connection port is a female-structured connection seat.

5. The patch antenna having the universal serial bus (USB) connection port as claimed in claim 1, wherein said antenna module further comprising a radiation portion used to transmit said radio frequency signal, and a ground portion.

6. The patch antenna having the universal serial bus (USB) connection port as claimed in claim 1, wherein said substrate is of a roughly rectangular shape.

7. The patch antenna having the universal serial bus (USB) connection port as claimed in claim 1, wherein the circuit elements of said signal conversion circuit are bonded on the surface of said substrate by means of the Surface Mounted Technology (SMT).

8. The patch antenna having the universal serial bus (USB) connection port as claimed in claim 1, further comprising a shell body, is used to accommodate and protect said substrate and said circuit elements disposed on said substrate.

9. The patch antenna having the universal serial bus (USB) connection port as claimed in claim 8, further comprising more than one fixing pieces, each of said fixing pieces is provided with a bond-ring and a suction-disc, said bond-ring is bonded on said shell body.

10. The patch antenna having the universal serial bus (USB) connection port as claimed in claim 1, further comprising a state indication lamp, used to indicate the signal transmission state of said radio frequency signal.

11. The patch antenna having the universal serial bus (USB) connection port as claimed in claim 10, wherein said state indication lamp is provided on a side of said shell body.
